(19) United States
(12) Patent Application Publication
(10) Pub. No.: US 2009/0043630 A1
(43) Pub. Date: Feb. 12, 2009

(54) Scheduling method for achieving revenue objectives

(76) Inventor: Constance Leigh Knieper, Howell, MI (US)

Correspondence Address: Constance Leigh Knieper, 7056 Richardson Road, Howell, MI, 48843, US

(21) Appl. No.: 12/228,480

(22) Filed: Aug. 13, 2008

Related U.S. Application Data
(63) Continuation-in-part of application No. PCT/US07/06975, filed on Mar. 21, 2007.

(51) Int. Cl. G06Q 10/00

(52) U.S. Cl. 705/8

(57) ABSTRACT

The scheduling method arranges and schedules tasks to ensure the completion of a revenue goal within a specified period of time. A revenue goal is first determined, and an associated task list is identified. Each task is assigned a completion time and the income generated. The tasks are arranged into categories based on completion time and the categories are then ordered according to income generated and assigned the lowest low-end (minimum) income generated according to the tasks within. The daily task completion time available is determined and the tasks are then scheduled to fill the available time so that the revenue goal is achieved or exceeded within the specified time period. The method steps may be stored on a computer readable medium and executed by a computer processor. Method instructions and data may also be accessed and executed via a computer network such as an internet-based system.

### TECHNICAL FIELD

The present invention relates to scheduling methods and systems, and more specifically to a scheduling method for use by a business or service provider to guarantee achievement of revenue objectives in a given time period.

### BACKGROUND ART

Businesses that revolve around providing a service to the public, such as doctors' offices, dentist's offices, vehicle repair shops, etc., often find that it is difficult to balance scheduling needs and desires with the financial (income) desires of the business. On one hand, every business has financial goals or revenue objectives that it seeks to achieve for any given period of time. On the other hand, the business is also interested in maintaining an income producing work environment, which includes developing a work schedule that is pleasing to employees and customers alike.

Several scheduling methods and techniques have been developed for helping such businesses plan and maintain a working schedule. However, almost all of these methods only take into consideration one of the above concerns of the business, either financial objectives or time management objectives. What is needed is a scheduling system and method that allows a service-provider business to develop an effective schedule that considers both the financial objectives and time management objectives of the business. Thus, a scheduling method for achieving revenue objectives in a given time period solving the aforementioned problems is desired.

### DISCLOSURE OF INVENTION

The disclosure is directed to a business scheduling method designed to achieve and/or exceed the revenue objectives in a given time period. A user first determines a revenue goal as well as the associated number of working days in which the goal is to be achieved. A list of tasks typically performed by a business is then created and each task is assigned a completion time and the income amount generated upon completion of each task. The tasks are arranged so that the tasks with identical completion times are placed in the same category. Within the categories, the tasks are placed in order from the lowest low-end income generated to the highest income generated. Each category is then assigned the lowest low-end (minimum) income generated according to the tasks within and a unique label such as a name, color, pattern, etc. The total task completion time available for each single working day in a specified time period is then determined and the categories are then arranged in a pattern to fill the task completion time available so that the sum of the minimum income generated is equal to or exceeds the revenue goal for the specified time period.

The disclosure is also directed to a computer-readable medium that includes stored instructions that are loadable into a computer main memory and are executable by a processor. When loaded into main memory and executed by the processor: a first set of instructions causes the processor to store a revenue goal for a specified time period; a second set of instructions causes the processor to determine the number of working days within the specified time period for which the revenue goal was determined; a third set of instructions causes the processor to record a list of tasks typically performed by a business; a fourth set of instructions causes the processor to record a completion time for each task; a fifth set of instructions causes the processor to record the income generated for each task. A sixth set of instructions causes the processor to arrange each task having an identical completion time into the same category, and each task in a category is ordered from lowest low-end income generated to highest income generated; a seventh set of instructions causes the processor to assign the lowest low-end (minimum) income generated to the category according to the tasks within; an eighth set of instructions causes the processor to assign a unique label to each category; a ninth set of instructions causes the processor to determine total task completion time available for each single working day in the specified time period; and a tenth set of instructions causes the processor to create a pattern of categories to fill the task completion time available for each single working day in the specified time period; and, an eleventh set of instructions causes the processor to arrange the categories in a pattern to fill the task completion time available so that the sum of the lowest low-end income generated is equal to or exceeds the revenue goal for the specified time period.

The disclosure further directed to a computerized scheduling system for use by a business/service provider for achieving revenue objectives in a given time period. The scheduling system includes a digital computer that is in operable communication with a memory storage device and a user interface. The computerized scheduling system includes a means for storing a revenue goal for a specified time period as well as a means for determining the number of working days within the specified time period for which the revenue goal was determined. The system further comprises a means for creating a list of tasks typically performed by the business and a means for storing the completion time for each task. The system also has a means for recording the income generated for each task and a means for arranging each task with an identical completion time into the same category, and then ordering each task within the category from lowest low-end income generated to highest income generated. The system further includes a means for assigning each category the lowest low-end (minimum) income generated and a unique label such as a name, color, pattern, etc. Finally, the computerized scheduling system has a means for arranging a pattern of categories to fill the task completion time available so that the sum of the lowest low-end (minimum) income generated in each category is equal to or exceeds the revenue goal for the specified time period.

### BRIEF DESCRIPTION OF THE DRAWINGS

FIG. 1 is a flowchart showing the steps of the scheduling method achieving revenue objectives in a given time frame according to the present invention.

FIG. 2 is a revenue goals chart for an illustrative example of the scheduling method for achieving revenue objectives in a given time frame according to the present invention.

FIG. 3 is a completion time and minimum income generated category chart for the illustrative example of the scheduling method for achieving revenue objectives in a given time frame according to the present invention.

FIG. 4 is a calendar/schedule template for the illustrative example of the scheduling method for achieving revenue objectives in a given time frame according to the present invention.

FIG. 5 is a block diagram of an exemplary system upon which the scheduling method for achieving and/or exceeding revenue objectives according to the present invention may be implemented.

### BEST MODES FOR CARRYING OUT THE INVENTION

The scheduling method for achieving revenue objectives in a given time period is a method that includes the steps of determining a revenue goal for a specified time period, determining the number of working days within the specified time period for which the revenue goal was determined, creating a list of tasks that are performed by the business or service provider, assigning the income generated to each task, recording a completion time for each task, arranging each task having an identical completion time into the same category, ordering the tasks in a category from lowest low-end income generated to highest income generated and assigning the lowest low-end income generated to each category according to the tasks within, determining the total task completion time available for each single working day in the specified time period, creating a pattern of categories to fill the task completion time available for each single working day in the specified time period, and arranging the categories according to the lowest low-end (minimum) income generated so that the sum of the lowest low-end (minimum) income generated is equal to or exceeds the revenue goal for the specified period.

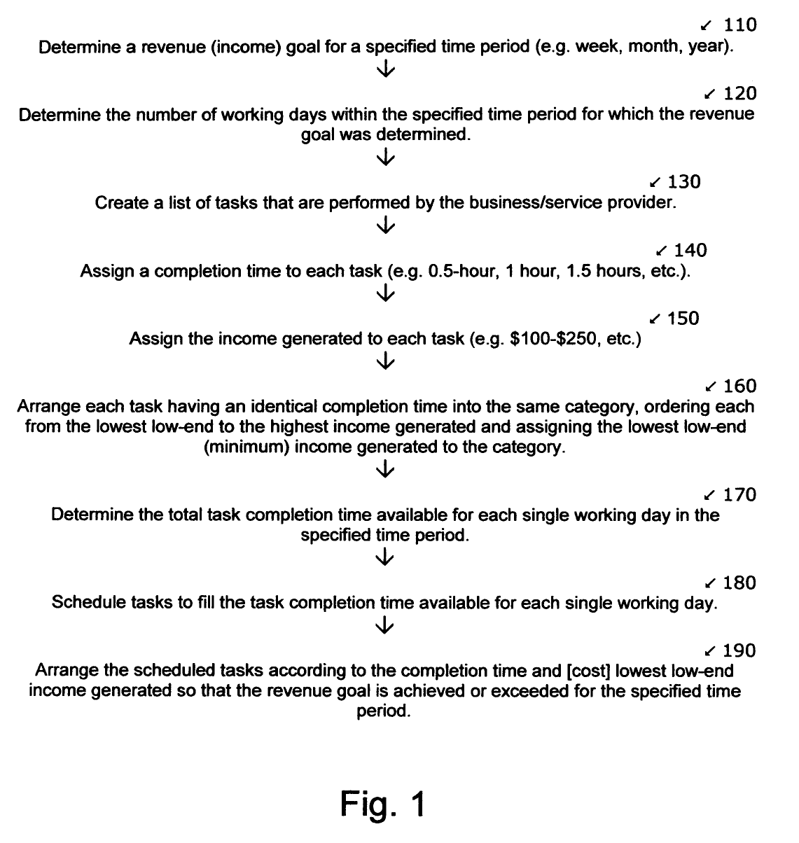

Such a scheduling method allows a service-provider business to develop an effective schedule that considers both the financial objectives and time management objectives of the business. Referring to FIG. 1, the scheduling method is intended for use by a business or service provider for achieving revenue objectives in a given time period and includes the steps of recording a revenue goal for a specified time period 110, determining the number of working days within the specified time period for which the revenue goal was determined 120, creating a list of tasks that are performed by the business or service provider 130, recording the completion time for each task 140, recording the income generated for each task 150, arranging each task having an identical completion time into the same category, assigning each category the lowest low-end (minimum) income generated according to the tasks within and assigning each category a unique label 160, determining the total task completion time available for each single working day in the specified time period 170, scheduling categories to fill the task completion time available for each single working day in the specified time period 180, and arranging the categories in a pattern so that the sum of the lowest low-end (minimum) income generated is equal to or exceeds the revenue goal for the specified time period 190.

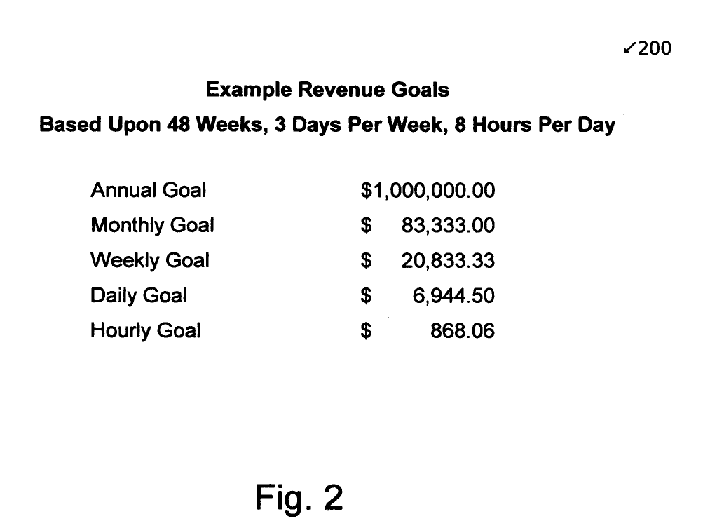

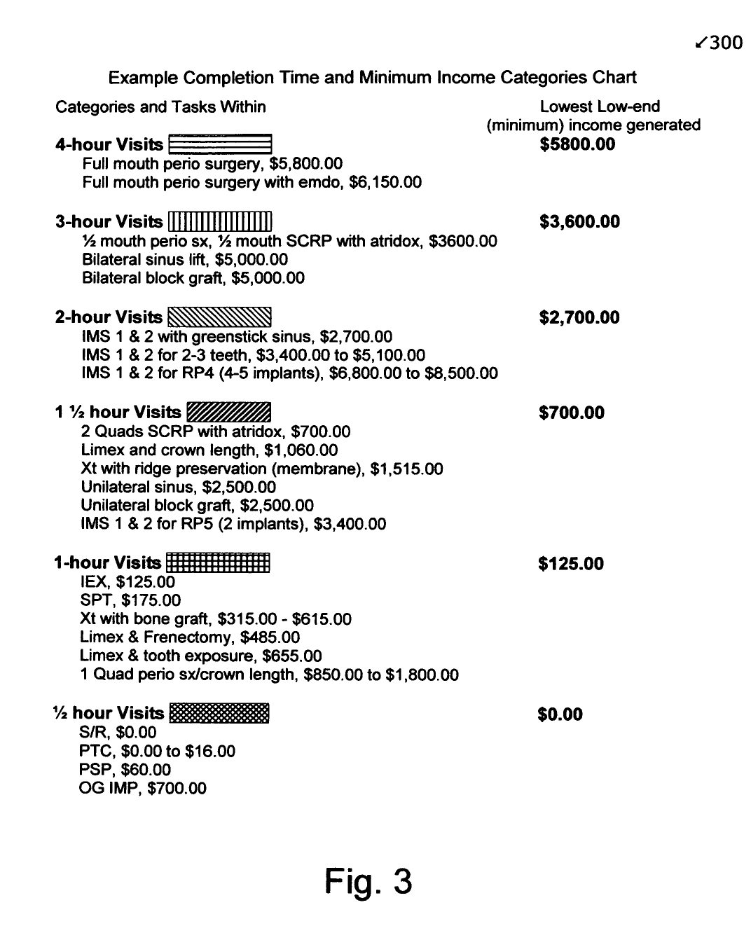

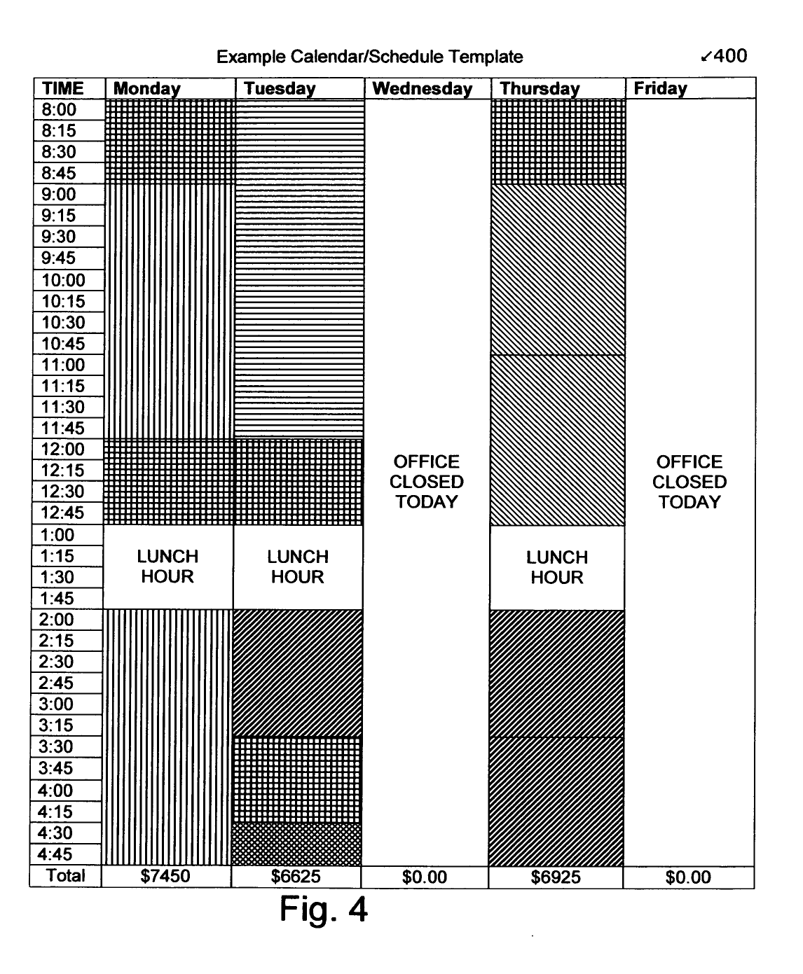

FIGS. 2-4 show a revenue goals chart 200, a completion time and minimum income generated category chart 300, and a calendar/schedule containing the patterns of categories 400, respectively, for use as illustrative examples of the scheduling method for achieving revenue objectives in a given time frame, as might be used by a dental practitioner.

The first step in the scheduling method is determining a revenue goal for a specified time period. Generally, a service provider business, such as a dental practitioner's office, will have longer-term income or revenue objectives, such as an annual revenue goal. Once this longer-term revenue goal is established, the business must then determine the number of working days that are going to be contained within that specified time period, taking into consideration such matters as holidays, desired vacations, days off, lunch breaks, office meeting times, etc. Once this has been established, the longer-term revenue goal can be broken down into smaller term goals, such as monthly, weekly, daily, or even hourly goals. By way of our illustrative example, production goals chart 200 shows how these calculations may play out for a typical dental practitioner. In the example, the practitioner has set an annual revenue goal of $1,000,000.00 and has established a schedule in which he or she will work forty-eight weeks of the year, three days a week, for eight hours a day. As such, the monthly, weekly, daily, and hourly goals can then be calculated, as shown in chart 200. These goals can be broken down even further, depending on how many practitioners are working toward the longer-term revenue goal.

The next step in the method involves creating a list of tasks that are performed by the service provider business. Once the tasks are determined, the completion times are assigned. The various completion times can be determined from past experience in the field and allow the practitioner enough time to complete the entire task. At this point, each task having an identical completion time is arranged into the same category, and within each category each task is ordered from the lowest low-end income generated to the highest income generated. Next, each category is assigned a value equal to the lowest low-end (minimum) income generated within the list of included tasks. By way of our illustrative example, completion time and minimum income categories chart 300 shows how these arrangements may play out for a typical dental practitioner. Once the tasks are arranged in this manner, they may also be assigned a distinctive code (different color, pattern, etc.) that may be used when scheduling tasks onto a calendar. Arranging the tasks in this way allows the business to use the worst-case scenario when developing the final scheduling templates in which case any revenue above such a scenario would result in an increase of revenue over the revenue goal.

The final steps of the scheduling method include determining the total task completion time available for each single working day and scheduling tasks to fill this task completion time. By way of our illustrative example, schedule/calendar 400 shows how a single week of the schedule may be planned out for a typical dental practitioner using the patterned coding system established in the completion time and minimum income generated categories chart 300. In this example, a weekly calendar is used to schedule tasks, with only three days of the week being available for appointments, as was established in the revenue goals chart 200. For each day in which tasks are completed, the minimum income generated total can be calculated, providing an easy way to calculate weekly or other shorter term totals thereafter, in an attempt to reach the ultimate longer-term revenue goal. In order to achieve the income or revenue goal, the tasks should be arranged according to completion time and minimum income generated so that the goal may be achieved or exceeded for the specified time period.

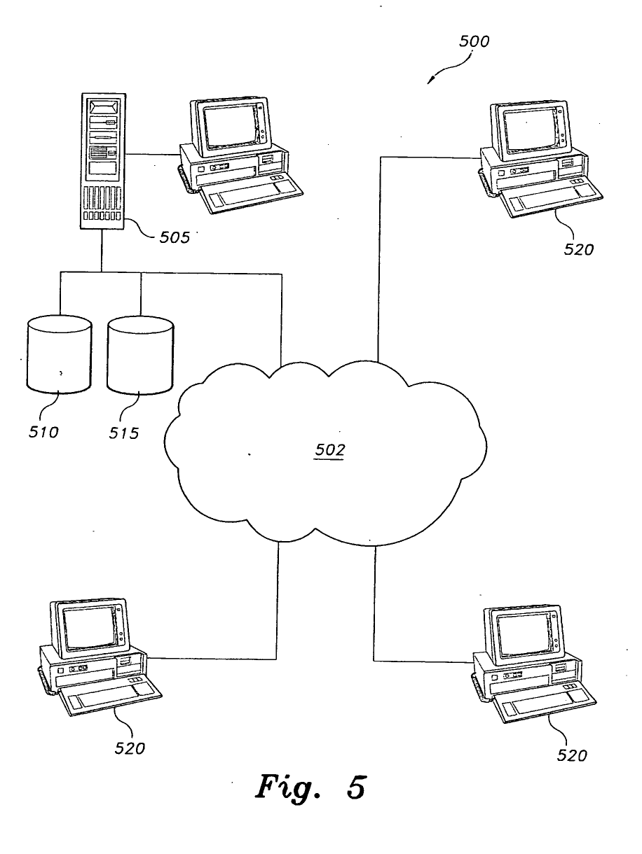

The aforementioned method steps can be performed on a digital computer in operable communication with at least one memory storage device and at least one user interface. Software programming may be stored in a program storage device, which is readable by a computing system in order to perform the method steps according to the present invention. The computing system may be a standalone computing device, such as a personal computer, PDA, Laptop computer, or the like. In addition, the computing system may employ a network of computers to perform the method steps outlined in FIG. 1. Moreover as shown in FIG. 5, as client-server system 500 can be provided in which user-client systems 520 communicate with server 505 via a network, such as the Internet 502, to perform the method steps. Server 505 may also include memory storage device 510 to store client tasks and associated records, and memory storage device 515 to store programmed instructions capable of performing the method steps.

The method may be carried out by software stored on a computer readable medium, the software containing instructions executable by a processor when loaded into main memory. The computer readable medium may be a compact disc (CD), a digital versatile disc (DVD), a floppy disk, a hard disk drive, or any other storage medium for digital data that can be read by a computer.

It is to be understood that the present invention is not limited to the embodiments described above, but encompasses any and all embodiments within the scope of the following claims.

1. A scheduling method for use by a business or service provider for achieving revenue objectives in a given time period, comprising the steps of:
Determining a revenue (income) goal for a specified time period;
Determining the number of working days within the specified time period for which the revenue goal was determined:
Creating a list of tasks typically performed by the business;
Recording the completion time for each task;
arranging each task having an identical completion time into the same category, including ordering each task in a category from lowest low-end income generated to highest income generated;
Assigning each category an income value equal to the lowest low-end income generated according to the tasks within;
Determining total task completion time available for each single working day in the specified time period;
Scheduling categories to fill the task completion time available for each single working day in the specified time period; and
Arranging the scheduled categories onto a calendar according to the minimum income generated so that the revenue goal is achieved or exceeded for the specified time period.

2. The scheduling method according to claim 1, further comprising performing each of the steps of claim 1 on a computer producing a scheduling guideline (instructions) and the corresponding scheduling templates.

3. The scheduling method according to claim 1, further comprising the step of subdividing the specified time period into completion time available and non-completion time available comprising the steps of
Recording the business hours of operation for each calendar day and week within the specified time period
Subtracting all non-working days, weeks, and hours within the specified time period;
Determining the total task completion time remaining within the specified time period and
Converting the remaining task completion time into the number of working weeks within the specified time period; and
Means for determining the weekly income coal according to the revenue objective in the given time period and the number of weeks of completion time available.

4. The scheduling method according to claim 1, further comprising the step of assigning to the categories a distinctive code for use in scheduling the tasks onto a calendar.

5. The scheduling method according to claim 4, further comprising the step of assigning the distinctive code based on minimum income generated for each category.

6. The scheduling method according to claim 5, further comprising the step of presenting calendar weeks of available completion time filled with the distinctive codes in pattern for achieving scheduling of tasks according to the revenue goal for the specified time period.

7. A medium readable by a computer having instructions stored thereon loadable into main memory and executable by a processor, the instructions including:
A first set of instructions which, when loaded into main memory and executed by the processor, cause the processor to store a revenue goal for a specified time period;
A second set of instructions which, when loaded into main memory and executed by the processor, cause the processor to determine the number of working days within the specified time period for which the revenue goal was determined;
A third set of instructions which, when loaded into main memory and executed by the processor, cause the processor to record a list of tasks typically performed by a business;
A fourth set of instructions which, when loaded into main memory and executed by the processor, cause the processor to record the completion time necessary to provide quality results for each task;
A fifth set of instructions which, when loaded into main memory and executed by the processor, cause the processor to assign an income generated range having a low-end and a high-end to each task;
A sixth set of instructions which, when loaded into main memory and executed by the processor, cause the processor to arrange each task having an identical completion time into the same category, wherein each task in a category is ordered from lowest low-end income generated to highest income generated;
A seventh set of instructions which, when loaded into main memory and executed by the processor, cause the processor to determine the lowest low-end (minimum) income generated per category and assign this value as the minimum income required for the category:
An eighth set of instructions which, when loaded into main memory and executed by the processor cause the processor to create a pattern of categories to fill the task completion time available for each single working day in the specified time period; and
A ninth set of instructions which, when loaded into main memory and executed by the processor, cause the processor to arrange the scheduled categories according to the minimum income generated so that the revenue goal is achieved or exceeded for the specified time period.

8. The medium readable by a computer according to claim 7, wherein said instructions further comprise:
A tenth set of instructions which, when loaded into main memory and executed by the processor, cause the processor to subdivide the specified time period into completion time available and non-completion time available comprising the steps of
recording the business hours of operation for each calendar day, week, and month within the specified time period
subtracting all non-working days, weeks, and hours within the specified time period
determining the total task completion time remaining within the specified time period and
converting the remaining task completion time into the number of working weeks within the specified time period; and
determining the weekly income necessary according to the revenue objective in the given time period and the number of weeks of completion time available.
an eleventh set of instructions which, when loaded into main memory and executed by the processor, cause the processor to display the revenue goal for each of the specified time periods to a user.

9. The medium readable by a computer according to claim 7, wherein said instructions further comprise:
a twelfth set of instructions which, when loaded into main memory and executed by the processor, cause the processor to assign a distinctive code to each category; and
a thirteenth set of instructions which, when loaded into main memory and executed by the processor, cause the processor to create a pattern of categories onto a calendar according to the distinctive code and the minimum income generated.

10. The medium readable by a computer according to claim 9, wherein the instructions further comprise a fourteenth set of instructions which, when loaded into main memory and executed by the processor, cause the processor to assign the distinctive code based on the lowest low-end income generated according to the tasks within each category.

11. The medium readable by a computer according to claim 10, wherein said instructions further comprise a fifteenth set of instructions which, when loaded into main memory and executed by the processor, cause the processor to output calendar weeks of completion time available filled with the distinctive codes in a pattern that achieves or exceeds scheduling of the tasks according to the revenue goal for the specified time period to an output device.

12. A computerized scheduling system for use by a business/service provider for achieving revenue objectives in a given time period, the scheduling system including a digital computer operable communication with a memory storage device and a user interface, the system further comprising:
means for recording a revenue goal for a specified time period;
means for determining the number of working days within the specified time period for which the revenue goal was determined;
means for creating a list of categories containing the tasks typically performed by the business;
means for recording the completion time necessary to provide consistent quality results for each task;
means for arranging each task having an identical completion time into the same category, each task in a category being ordered from lowest low-end income generated to highest income generated;
Means for assigning the lowest low-end income generated to each category as the minimum income generated according to the tasks within;
means for determining total task completion time available for each single working day in the specified time period;
means for scheduling categories to fill the task completion time available for each single working day in the specified time period; and
means for arranging the scheduled categories according to the minimum income generated so that the revenue goal is achieved or exceeded for the specified time period.

13. The computerized scheduling system according to claim 12, further comprising:
means for subdividing the specified time period into completion time available and non-completion time available comprising the steps of
recording the hours of business operation for each calendar week within the specified time period;
subtracting all non-working weeks, days, hours, and minutes for each calendar week within the specified time period;
determining the total number of working days available within the specified time period;
converting the total number of working days into total number of working weeks within the specified time period; and
means for displaying the revenue goal for each of the specified time periods to a user of the system.

14. The computerized scheduling system according to claim 12, further comprising a means for assigning the categories a distinctive code based on completion time and minimum income generated for scheduling the categories onto a calendar.

15. (canceled)

16. The computerized scheduling system according to claim 15, further comprising; a means for displaying a calendar filled with the distinctive codes in a pattern scheduling the categories according to the revenue goal for the specified time period.
